(19) United States
(12) Patent Application Publication
(10) Pub. No.: US 2017/0248759 A1
(43) Pub. Date: Aug. 31, 2017

(54) An optical assembly and a method for producing such

(71) Applicant: Corelase Oy, Tampere (FI)

(72) Inventor: Arto Salokatve, Tampere (FI)

(21) Appl. No.: 15/519,849

(22) PCT Filed: Oct. 20, 2014
(86) PCT No.: PCT/FI2014/050790

§ 371 Date: Apr. 18, 2017

(51) Int. Cl. G02B 6/28; G02B 6/26; G02B 6/255; G02B 6/02; G02B 6/04

(52) U.S. Cl. CPC G02B 6/2856; G02B 6/02042; G02B 6/04; G02B 6/255; G02B 6/26

(57) ABSTRACT

The invention relates to an optical assembly for producing such. The invention also relates to the use of the optical assembly. Laser radiation received via a bundle of individual optical feed fibers is guided to a fiber laser fiber. Each feed fiber has a cladding layer surrounding the core of the fiber to provide total internal reflection in said core, and the cladding layers of the fibers are fused at least partially together to form a zone containing the cores of the feed fibers arranged in a cylindrical configuration inside said zone This configuration provides the shaping of an annular laser beam that can be fed into a fiber laser fiber having an annular light guiding zone and to present the annular laser beam e.g. to a workpiece.

### FIELD OF THE INVENTION

The invention relates to fiber-optic components and, in particular to adiabatic optical fiber couplers and their use. The invention relates also to a method of bundling optical fibers for manufacturing a fiber-optic component. The invention is especially suitable for materials processing by using high power laser beams.

### BACKGROUND OF THE INVENTION

High power laser beams are widely used in materials processing, such as cutting and o welding metals. The processing speed by using laser beams depends not only various material characteristics, such as material composition and thickness, but also on characteristics of the laser beam itself, such as wavelength, beam quality and beam profile. Especially for metal cutting applications, the beam profile, i.e. the spatial intensity pattern of the beam, has been observed to affect the cutting speed and quality. Typical beam profiles of lasers can be approximated with either Gaussian (bell-shaped) shape or super-Gaussian shape. Gaussian profiles are generated by single-mode laser sources, while super-Gaussian profiles are generated by multimode lasers. An extreme case of super-Gaussian shape is the so-called top-hat profile which has constant intensity within the beam and zero intensity outside of the beam. A common feature of Gaussian and top-hat beams is that substantial amount of intensity resides in the center of the beam.

When cutting metal with a laser beam, the laser beam is typically condensed through a condenser lens into a spot of 100-500 μm to increase energy density and instantaneously heat the workpiece to a metal melting point of 1500 degrees or over so that the workpiece melts or sublimates. At the same time, an assist gas may be fed to remove molten material and cut the workpiece. When the workpiece is a thick mild steel sheet (carbon steel sheet), oxygen is used as the assist gas to generate oxidization reaction heat and utilize the heat as well for cutting the workpiece.

A laser beam of a one-micrometer waveband from a solid-state laser or fiber laser realizes a very high optical energy intensity and absorbance on a metallic work compared with a laser beam in the ten-micrometer waveband from of a CO2 laser. However, if a one-micrometer waveband laser beam with a Gaussian beam is used with an oxygen assist gas to cut a mild steel sheet workpiece, the melt width on the top face of the workpiece widens unnecessarily and impairs kerf control. In addition self-burning may occur to deteriorate the quality of the laser cutting. In EP2762263 is however found that forming a laser beam of the fiber laser into a ring beam and cutting a workpiece with the ring beam provide the same effect as that provided by the CO2 laser.

Indeed, cutting metals with a laser beam having an intensity profile that can be approximated with an annular or a “doughnut” shape has yielded good results in terms of cutting speed and quality. For instance, it has been observed that cutting of a metal of a given thickness can be performed at much lower power when using a doughnut beam instead of more conventional beam profiles. Therefore, some companies making high power laser sources for such applications have developed methods to produce beam profiles approaching or approximating the doughnut shape. Some of these methods include the use of ring-modes, e.g. transverse (TEM) modes, from the laser resonator or shaping the beam by using sophisticated and often proprietary electro-optical methods. In a doughnut beam the intensity profile has a dip or a region of relative darkness at the center of the beam, and the region of maximum radiation intensity is forming a ring-like pattern around the said central dip.

In U.S.20110293215 s disclosed a solution to convert a Gaussian mode beam to an annular mode beam by using a hollow optical fiber, or a fiber coupled micro-axicon lens assembly.

From the document JP2013139039 it is known to direct a plurality of optical fibers to a corresponding number of collimating lenses which makes the laser beam from two or more optical fibers parallel. The solution has a condensing lens which condenses the parallel light from the collimating lenses, while the optical fibers are moved through drive mechanisms to, among other shapes, to create annular beams.

In U.S. Pat. No. 7,348,517 is discussed the problem of removing molten material of the workpiece, e.g. when cutting steel plates with a laser beam. An assist gas like oxygen or an inert welding gas is injected coaxially with the laser beam so as to locally remove the molten material. Maintaining an appropriate gas pressure at thick plates the power for blowing away the molten metal tends to become inadequate. A TEM10 mode is used to create an annular beam, the collecting properties of which is optimized by modifying the configuration of a gas laser oscillator and/or by modifying the configuration of the optical mirror and lens system that is used.

EP0464213 shows a method of cutting a workpiece such as a thick plate of mild steel with a laser beam by cutting the workpiece with a laser beam mainly in a ring mode and by applying a gas to the surface of the optical system to cool the system. A KCL (potassium chloride) lens is used as a focusing lens.

Finally, WO2009003484 shows an adiabatic optical coupler that combines a first optical segment consisting of bundled optical fibers with a second segment hawing a waveguide comprising an inner cladding so that light is guided into a ring shaped region. The inner cladding has a reduced refractive index relative to un-doped silica to confine the light to the ring shaped guide region.

In materials processing applications using a laser beam it is generally favorable to maximize the brightness of the beam. Brightness is defined as the power per unit solid angle and unit area. As an example of the importance of brightness, increasing the brightness of a laser beam means that the laser beam can be used to increase the processing speed or the material thickness. Therefore, in order to maximize brightness of the light emitted by a bundle of optical fibers the cores of the fibers should be as dose to each other as is practically achievable.

For instance, bundling a number of optical fibers having the cladding diameter of 125 μm and the core diameter of 20 μm does not produce a high brightness, because the cores of the fibers in the bundle lie relatively far away from each other. If one wishes to increase the brightness of the bundle, distance between the cores of the fibers need to be reduced. Prior art solutions have not addressed this issue properly. Any brightness that is lost due to oversized fibers and disruptions or deviations in the light path, cannot be reclaimed.

### SUMMARY OF THE INVENTION

It is an aim of the present invention to achieve a robust way of generating an annular or ring-like laser radiation pattern with a very high brightness and intensity. Such ring-like intensity distribution patterns have immediate industrial applications in materials processing by using laser beams.

The aim of the invention is achieved by the optical assembly and method according to the independent claims.

The inventive optical assembly and method is directed, in particular, to fiber-optic components operating in the 100 W to kW power regime. In particular, the throughput of the component may be at least 100 W, in particular at least 1 kW. The feed fibers of the component may be, or may be coupled to, fiber lasers or any other fiber-delivered laser sources. A sufficient amount of brightness is maintained by using thin fibers, by fusing the cladding of the fibers and by eliminating or at least minimizing any disruptions or deviations in the light path. In such a way the cores of the fibers are brought dose to each other, relative to the core diameters.

According to one aspect of the present invention an optical assembly for guiding laser radiation received via a bundle of individual optical feed fibers is provided. Each feed fiber has at least one cladding layer surrounding the core of the fiber. According to the invention, the cladding layers of the fibers are fused at least partially together in a cylindrical confinement to form a zone containing the cores of at least part of the feed fibers, arranged in a cylindrical configuration inside the zone. This will provide an annularly shaped light guide, with which a laser beam may be fed e.g. to a “doughnut” fiber laser fiber. The present invention can be used with any kind of fiber laser devices where the intensity pattern of the laser radiation need to have an annular shape.

In an embodiment, the bundle of individual optical feed fibers are fused to form an annular zone containing the cores of the feed fibers arranged in a cylindrical configuration inside said zone. The bundle of individual optical feed fibers may also comprise a further optical fiber being fused in the center of the annular zone to make it possible to provide a laser beam also in the center of the annularly shaped laser beam. This fiber in the center may also be a dummy or dark fiber which only task may be to assist in keeping the feed fibers in their positions along the periphery of a tubular mold where the fibers are fused together.

According to one aspect of the invention, a method for producing an optical assembly for guiding laser radiation received via a bundle of individual optical feed fibers to a fiber laser fiber is provided. The inventive method includes the steps of:
providing a cylindrically-shaped mold,
fitting a plurality of optical feed fibers in said mold along the periphery of the cylinder, each fiber having a core and at least one cladding layer surrounding the core to provide total internal reflection in said core,
applying heat to and at least partially fusing together the cladding material of said fibers in said mold and forming a zone with at least part of the cores of said feed fibers arranged in a cylindrical configuration in the fused cladding material.

According to embodiments, fusing the cladding material of said fibers is fused to form an annular zone containing the cores of said feed fibers arranged in a cylindrical configuration inside said zone. A further optical fiber may be fused in the center of the annular zone.

Preferably the fusing is performed by using a tubular mold having a bore forming a waist section, and by applying heat to fuse the bundle of fibers at the waist section. The feed fiber cores are relatively dose spaced, due to the fusing together of the bundle of fibers. The fused portion of the fiber bundle may thus form a single piece of glass, or at least a compact zone of fused fiber cladding.

The annular shaped laser beam generated with an inventive optical assembly is fed into a fiber having a core capable of guiding laser radiation. The feed fibers cores are advantageously arranged to reside in an annular zone or region of a predetermined size that overlaps an annular core region of a doughnut fiber laser fiber. Such core regions have higher refractive index than the materials surrounding it, which provides for total internal reflection in the core region. The various embodiments are defined in the dependent claim. When the annular zone has a refractive index that is higher than that in the materials being encircled by and outside said annular zone, the laser beam is guided to a workpiece to be e.g. cut with the least possible degradation in the annular intensity profile and attenuation of the optical power and intensity.

To summarize, the method described is a simple and efficient way of generating ‘ring-like’ beam profiles for fiber-coupled laser sources. In the preferred method of splicing together the first and second optical elements, no free-space optics is required. No complicated electro-mechanic and electro-optical systems are used. Single-mode or multi-mode laser sources can be used at the input, and unlike in some published ring-generators, one does not need to after the resonator properties of the laser sources for generating a ring-like intensity distribution.

Considerable advantages are obtained by means of the invention. As the component is preferably a fused all-glass component, no alignment errors or destructive effects due to contamination can occur. The component will be stable with time and with environmental changes, so the quality of materials processing will not be affected by such influences. Particular advantages are obtained in components directed to or used in laser welding and laser cutting.

Next, embodiments of the invention are described in more detail with reference to the attached drawings.

### BRIEF DESCRIPTION OF THE DRAWINGS

FIG. 1 shows a cross-section of a bundle or preform of optical fibers;

FIG. 2 shows a fused bundle that forms an optical assembly according to one embodiment of the invention;

FIGS. 3a and 3b illustrates the structure and refractive properties of an annular fiber laser fiber;

FIG. 4a shows a tubular molding device according to one embodiment of the invention;

FIG. 4b shows a tubular molding device according to another embodiment of the invention;

FIG. 5 illustrates a fused bundle of input fibers according to one embodiment of the invention;

FIG. 6 illustrates a coupling zone between an inventive optical assembly and a fiber laser fiber.

### DETAILED DESCRIPTION OF EMBODIMENTS

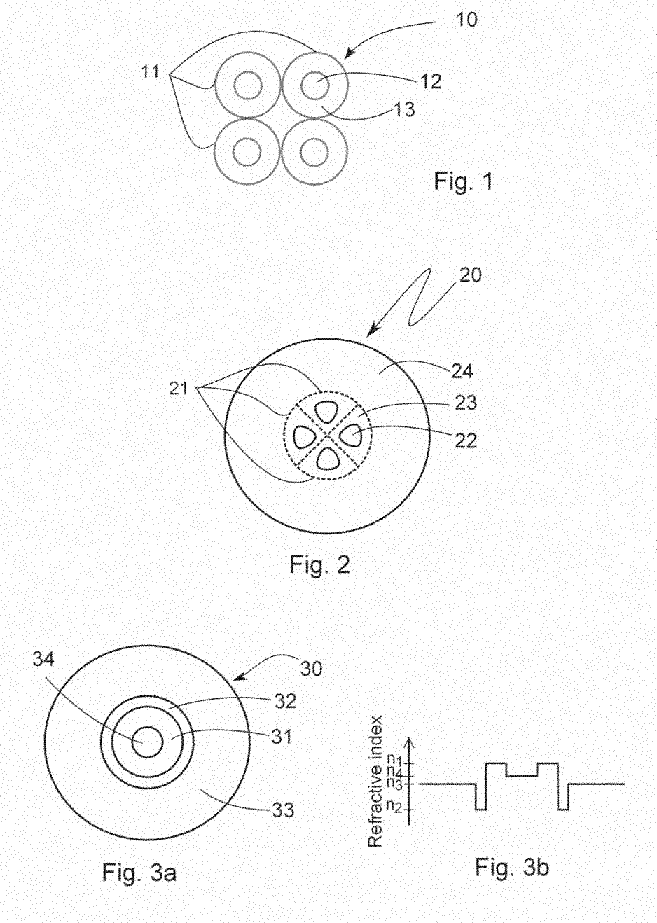

FIG. 1 shows a cross-section of a bundle 10 of optical fibers 11 that constitutes a preform for an optical element according to one embodiment of the invention. The bundle has N fibers (here N=4). Each fiber 11 has a core 12 and a cladding 13. The cladding is made of material having a lower refractive index than that of the cores 12. As is well known for those familiar with the art, light launched into the core of such a fiber (also called step-index fiber) will be guided by the refractive index step between the core and the cladding, and hence will remain inside the core according to the principle of total internal reflection.

The fibers in the bundle are according to the invention very thin in order to maximize the brightness of the optical pattern formed by the multiple cores. In particular, the diameter of the fibers may be as low as 40 μm, or even less. As the handling and bundling of such thin fibers is very challenging, the fusing of the bundle is preferably performed inside a supporting cylindrically-shaped mold for improved manufacturability.

FIG. 2 shows a fused bundle 20 that forms an optical assembly according to one embodiment of the invention. A fused bundle 20 is made by first forming a preform 10 of bundled fibers as shown in FIG. 1, and then puffing the preformed bundle through a heated cylindrical mold, that may consist of a capillary tube. When passing the mold, the cladding 23 of the fibers 21 are fused together in a controlled fashion. The spatial pattern formed by the cores 22 is determined by the preform and the mold. Here the fused bundle has N core regions 22 (here N=4). The cladding regions 23 and possibly also the core regions 22 are deformed from their initial generally round shape by the fusing process. The dashed lines in FIG. 2 illustrate the approximate deformed boundaries of the individual fibers 11 of the bundle of FIG. 1. Such physical interfaces may disappear in the fusing process.

The final physical dimensions and spatial separations of the cores of the fused bundle 20 are determined by the fiber dimensions and the degree of fusing of the cladding. The outer layer 24 may consist of the tubular mold. Thus the capillary tube has been fused together with the fiber to form a solid section of glass. This provides a fused fiber bundle with improved mechanical robustness, forming a strong solid piece of glass as the fiber bundle and the capillary tube are fused together. Alternatively, if the mold is not part of the structure, any suitable cladding may be formed on the fused fiber. The formed fiber bundle 20 can be polished or cleaved with conventional methods to form a flat end or interface surface, and common methods of fiber optics can be used to further process the resulting fiber, such adding an outer protective polymer coating, stripping off the coating, etc.

FIG. 3a shows a fiber laser fiber 30 with an annularly formed light guide (doughnut fiber) that receives the laser beam that is output by the fused fiber bundle of FIG. 2. The doughnut fiber 30 has a central cladding 34, an annular light guide or core 31, a primary cladding 32 and a secondary cladding 33. The doughnut fiber 30 can be polished or cleaved to form a flat plane to it by using well-known methods of fiber optics.

The fused fiber bundle 20 and the doughnut fiber 30 may be optically coupled together either by splicing them together or by using free-space optics (lenses etc.) between them. The laser radiation coupled from the cores of the feed fibers 21 into the core 31 of the doughnut fiber forms a spatial intensity distribution that can be approximated by a doughnut shape at the exit face of the doughnut fiber. This spatial intensity pattern can be further imaged with processing optics onto the workpiece.

FIG. 3b shows an example of a possible refractive index profile of the doughnut fiber 30 of FIG. 3a. The central cladding 34 has an index of n₄ and the primary cladding 32 has an index of n₂. The core 31 has an index of n₁, where n₁>n₂ and n₁>n₄ in order for light to be and remain guided in the core 31. The index n₃ of the secondary cladding has no definite restriction in terms of its magnitude, but since in practice this region is generally made of pure fused silica, n₃ can be about 1.45. The refractive index of fused silica can be tailored by doping it with impurities. For instance, doping fused silica with Germanium results in an increase of the refractive index, while doping it with Fluorine results in reduction of the refractive index. Therefore the core 31 of the doughnut fiber may be made of Ge-doped fused silica and the primary cladding 32 of F-doped fused silica. The central cladding 34 and secondary cladding 33 may be made of un-doped fused silica.

Obviously, other material choices exist that satisfy the requirements for the refractive index values of the different regions of the fiber 30. As some light may also be launched into the central cladding 34, the index n₂ of the primary cladding may be smaller than the index n₄ of the central cladding to ensure that light launched into the central cladding 34 will not propagate through the primary cladding 32.

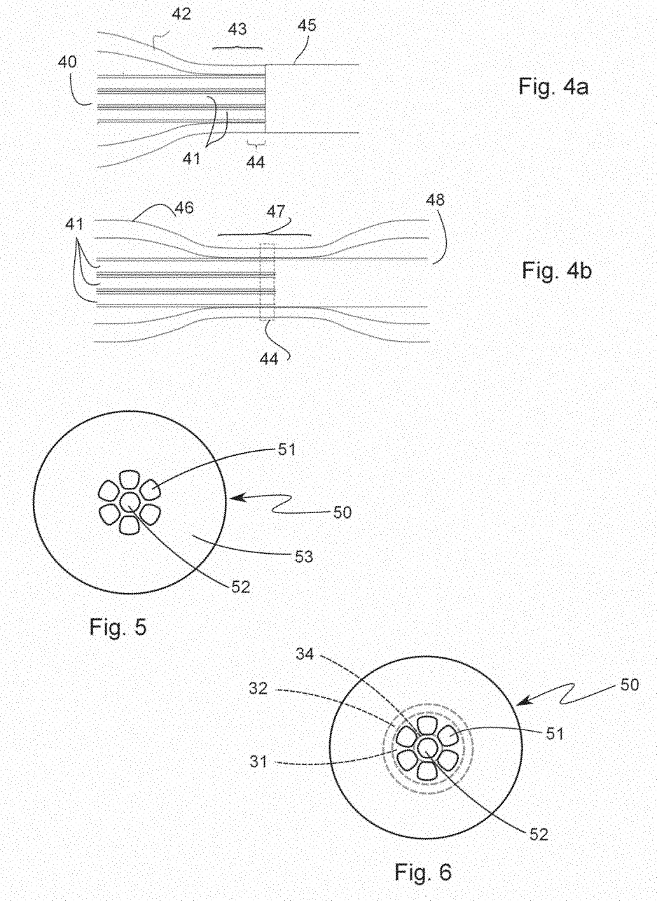

With reference to FIG. 4a, according to one embodiment, the tubular molding device comprises a capillary tube 42 (e.g. fused silica, quartz, doped quartz etc.) that has been tapered by a glass drawing method in order to obtain a waist portion 43 of some suitable length (e.g. 1 mm-5 cm, preferably 3 mm-3 cm) of a substantially constant diameter. A bundle 40 of feed fibers 41 is fitted within the capillary tube 42. The inner diameter of the capillary tube 42 at the waist portion 43 is designed to be slightly larger than the outer dimension of the bundle 40 of feed fibers 41, for example about 1 μm larger. The bundle 40 may be organized into a close-packed configuration by a suitable bundling aid tool and bundle geometry may be fixed or secured by the feed fibers having an adhesive coating (not shown) or alike.

Within the waist portion 43 of the capillary tube, the bundle of feed fibers 41 becomes fused with the wail of the capillary tube 42 e.g. by applying heat at a heating zone 44, preferably to achieve adiabatic (gradual) fusing of the fibers. The result is the fused fiber bundle 45.

In FIG. 4b is shown an alternative embodiment where the tubular mold 46, having a waist portion 47, does not form part of the fused fiber bundle 48. Both embodiments of FIGS. 41 and 4b illustrate an important feature of the present invention, i.e. the fiber bundle to be fused is made subject to very gentle manufacturing steps to preserve adiabatic light guidance through the optical assembly. In practice this means deformation, bending and disruption of the fiber cores are avoided to the extent possible.

It should be noticed that usually, due to the geometries involved, the cores of the fibers undergo in cross-section a change of shape from generally circular shape to non-circular shape as the fibers of the bundle and capillary fuse together and air pockets between fibers and between them and the inner wall of the cylindrical mold vanish due to the reflow of glass during fusing. The change of fiber shape must be done in a gradual fashion (adiabatically) along the length of the fused region. The gradual shape change can be accomplished by controlling the heating power in a heating zone like the zone 44 in FIGS. 4a and 4b, as the fiber moves along the length of an elongated fusing region with constant velocity, or by increasing the velocity of the heat source with constant heating power, or both in combination. The minimum heating power should be such that the cores of the feed fibers 41 remain in their original shape and that the capillary (or mold) is not substantially collapsed. A gradual change of core shape is essential for achieving low losses and low degradation in the brightness of the laser radiation.

FIG. 5 shows a cross-section of an embodiment of the invention with a fused fiber bundle 50 with seven feed fibers. In this close-packed configuration of feed fibers one of the fibers is located in the center of the bundle, while the remaining six fibers are located in a cylindrical fashion and appear in the cross-section arranged in a circle. The peripheral fibers have cores 51 and the central fiber has a core 52. The solid glass matrix 53 consists of the claddings of the 7 individual feed fibers, a capillary mold tube and/or other claddings applied around the original fiber bundle.

FIG. 6 shows the optical interface between the fused bundle 50 of FIG. 5 and the doughnut fiber 30 of FIG. 3a. For clarity, dashed lines from reference numbers are pointing to structures represented by dashed lines. The cores 51 of the annularly arranged and now fused feed fibers are aligned to launch optical power into the core 31 of the doughnut fiber 30. Correspondingly, the core of the central fiber 52 of the fused bundle 50 is designed to launch optical power into the central cladding 34 of the doughnut fiber 30. The optical intensity at the center of the doughnut fiber 30 will thus not be zero if optical power is launched into all of the fibers of the fused bundle 50.

The dimensions of the fused bundle 50 and the doughnut fiber 30 may also be chosen so that the peripheral fibers 51 have an overlap with the central cladding 34 of the doughnut fiber 30, as it in some cases may be preferred that some optical power from the cores 51 also enters the central cladding 34. Any optical power launched into the central cladding 34 will not remain constrained to the cladding, since its refractive index n₄ is smaller than the index n₁ of the core 31.

If on the other hand the overlap between the cores is 100%, that is, all cores 51 of the fiber bundle 50 fit inside the core 31 of doughnut fiber 30, and the core 52 is kept essentially dark, no optical power will be launched into the central cladding 34. Thus, the central cladding 34 will also appear dark, i.e. it will have practically zero intensity.

Thus, the spatial configuration and dimensions of the core regions of the optical elements 30 and 50 define the total overlap of cores. In most cases it is preferable not to launch any power into the primary cladding 32, as this light will not be contained in the core 31 and the central cladding 34, and thus could be regarded as undesirable losses to the component. This would be especially true for the important practical case of n₃>n₂, in which case any light launched into the primary cladding 32 would also leak into the secondary cladding 33.

It is to be understood that the embodiments of the invention disclosed are not limited to the particular structures, process steps or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the darns set forth below.

1. An optical assembly for guiding laser radiation received via a bundle of individual optical feed fibers, each feed fiber having at least one cladding layer surrounding the core of the fiber to provide total internal reflection in said core, wherein the cladding layers of the fibers fused at least partially together in a cylindrical confinement to form a zone containing at least part of the cores of the feed fibers arranged in a cylindrical configuration in said zone to provide an annularly shaped light guide.

2. The optical assembly according to claim 1, wherein the bundle of individual optical feed fibers are fused to form an annular zone containing the cores of the feed fibers arranged in a cylindrical configuration in said zone.

3. The optical assembly according to claim 2, wherein the bundle of individual optical feed fibers further comprises a further optical fiber being fused in the center of said annular zone to provide a light guide in the center of said annularly shaped light guide.

4. A method for producing an optical assembly for guiding laser radiation received with a bundle of individual optical feed fibers, comprising the steps of:
providing a cylindrically-shaped mold,
fitting a plurality of optical feed fibers in said mold along the periphery of the cylinder, each fiber having a core and at least one cladding layer surrounding the core to provide total internal reflection in said core, and
applying heat to and at least partially fusing together the cladding material of said fibers in said mold and forming a zone with at least part of the cores of said feed fibers arranged in a cylindrical configuration in the fused cladding material.

5. The method according to claim 4, further comprising fusing the cladding material of said fibers to form an annular zone containing the cores of said feed fibers arranged in a cylindrical configuration inside said zone.

6. The method according to claim 5, further comprising fusing a further optical fiber in the center of said annular zone.

7. The method according to claim 4, further comprising using as said cylindrically-shaped mold a tubular mold having a bore forming a waist section, and by applying heat to fuse said bundle of fibers at said waist section.

8. (canceled)
